(19) United States
(12) Patent Application Publication
(10) Pub. No.: US 2022/0167642 A1
(43) Pub. Date: Jun. 2, 2022

(54) FAT BLENDS, EMULSIONS THEREOF, AND RELATED USES

(71) Applicant: Firmenich SA, Satigny (CH)

(72) Inventors: Philipp ERNI, Satigny (CH); Mark RUBIN, Satigny (CH); Howard MUNT, Satigny (CH); Robert WAGNER, Satigny (CH); Mirela PASCU, Satigny (CH)

(73) Assignee: Firmenich SA, Satigny (CH)

(21) Appl. No.: 17/600,949

(22) PCT Filed: Jun. 26, 2020
(86) PCT No.: PCT/EP2020/068090

§ 371 Date: Oct. 1, 2021

(30) Foreign Application Priority Data
Jun. 28, 2019 (EP) 19183261.7

(51) Int. Cl. A23J 3/22; A23L 33/115; A23L 27/00; A23L 33/185; A23K 20/147; A23K 20/158; A23K 50/40

(52) U.S. Cl. CPC A23J 3/227; A23L 33/115; A23L 27/80; A23V 2002/00; A23K 20/147; A23K 20/158; A23K 50/40; A23L 33/185

(57) ABSTRACT

The present disclosure relates generally to fat blends, emulsions of fat blends (such as water-in-oil fat blends), and uses thereof. In certain embodiments, certain water-in-oil emulsions disclosed herein can be suitably used to improve the organoleptic properties, the perceived texture, the perceived juiciness, or the mouthfeel of various foods, pet foods, or feed products, such as meat analogue products. In certain aspects, the disclosure also relates to the use of the water-in-oil emulsion disclosed herein as a partial or full replacement of animal in various foods, pet foods, or feed products. In certain aspects, the disclosure also relates to methods of preparing water-in-oil emulsions and various food products comprising such water-in-oil emulsion.

### CROSS-REFERENCE TO RELATED APPLICATIONS

This application claims priority to European Patent Application No. 19183261.7, filed Jun. 28, 2019, which is hereby incorporated by reference as though set forth herein in its entirety.

### TECHNICAL FIELD

The present disclosure relates generally to fat blends, emulsions of fat blends (such as water-in-oil fat blends), and uses thereof. In certain embodiments, certain water-in-oil emulsions disclosed herein can be suitably used to improve the organoleptic properties, the perceived texture, the perceived juiciness, or the mouthfeel of various foods, pet foods, or feed products, such as meat analogue products. In certain aspects, the disclosure also relates to the use of the water-in-oil emulsion disclosed herein as a partial or full replacement of animal in various foods, pet foods, or feed products. In certain aspects, the disclosure also relates to methods of preparing water-in-oil emulsions and various food products comprising such water-in-oil emulsion.

### DESCRIPTION OF RELATED ART

Meat products are widely consumed by humans and other animals, and continue to make up an increasing proportion of the caloric intake of humans worldwide. Even so, meat production is far less efficient than plant production on a calorie-per-land-area basis. Thus, increased meat consumption places a higher demand on the conversion of forests (such as rain forests) to arable land, and a concomitant increase in greenhouse gas emissions. Moreover, meat often contains high amounts of longer-chain saturated fats, which tend to have a deleterious effect on human health and well-being. But humans tend to enjoy the consumption of meat products, as the savory and satiating taste of meat products is often difficult to obtain from plant-based sources.

In recent years, there has been an increased effort to develop plant-based materials that exhibit many of the desirable features of meat-based food products. Such plant-based materials may be referred to as “meat analogues.” Despite significant efforts to develop such meat analogue technology, the resulting products only superficially resemble natural meat. Meat products contain a number of natural flavor compounds, and other similar such compounds are generated during the cooking process. Such compounds include fatty acids, as well as certain aroma compounds. Such compounds are often lacking from meat analogues, or are included in a way that created a very different taste experience for the consumer. The primary components of such meat analogues are typically plant protein and water. By contrast, many of the flavor compounds that contribute to meat's desirable taste are hydrophobic in nature. Therefore, even when present in meat analogues, are not delivered to the mouth in the same way. Thus, there is a continuing need to develop ways to improve meat analogue products, so that the experience of eating such products more closely simulates that of eating real meat products.

### SUMMARY

The present disclosure relates to the discovery of certain compositions that beneficially deliver certain aroma compounds in the presence of vegetable proteins that allows for a more true simulation of the taste profile of actual meat products. For example, it was discovered that one factor that leads to flavor imbalance in meat analogues is the selective binding of certain aroma compounds to plant proteins, which can create a distorted, non-culinary, non-authentic flavor profile for the product. To provide a partial solution to this problem, the present disclosure provides fat compositions, and emulsions thereof, that ca suitably reduce the binding of lipophilic flavor compounds, such as aroma compounds, which often have higher log P values (for example, log P>1.5), as well as the binding of other compounds like thiols, disulfides, and the like, to the plant protein matrix of food products, pet food products, or feed product more particularly, meat analogues. Note that “log P” in this context refers to the base-10 log of the partition coefficient between water and 1-octanol.

By using the compositions disclosed herein in meat analogue products, one can improve one or more of the aroma profile, the taste profile, the sensory perception, and the texture perception of meat analogues, so as to more truly match such characteristics of real meat products, both during the consumption and the preparation (e.g., at-home cooking) of the meat analogue products.

The compositions disclosed herein can, when used in certain water-in-oil emulsions, reduce the binding of both hydrophilic and lipophilic compounds to the plant protein matrix of the meat analogue product. In some cases, by applying the flavor compounds in an emulsified format, certain flavored water-in-oil emulsion of the present disclosure can provide a more authentic flavor profile to that found in real met products, and, in some instances, without using a high concentration of the flavor compounds in the resulting meat analogue product.

In a first aspect, the disclosure provides fatty compositions comprising solid fat particles and a liquid oil, wherein the solid fat particles are dispersed within the liquid (edible) oil. In some embodiments thereof, the fatty composition comprises an emulsifier. In some embodiments thereof, the fatty composition comprises one or more fat-soluble flavor compounds, fat-soluble aroma compounds, or combinations thereof. In some embodiments, the weight-to-weight ratio of liquid (edible) oil to solid fat particles ranges from 30:70 to 99:1. In some embodiments where an emulsifier is present, the emulsifier is present in a concentration ranging from 0.2 weight percent to 35 weight percent, based on the total weight of the fatty composition.

In a second aspect, the disclosure provides emulsions comprising a continuous phase and a dispersed phase, wherein one of the continuous phase or the dispersed phase comprises the fatty composition of the first aspect, and the other of the continuous phase or the dispersed phase comprises an aqueous medium. In some embodiments, the aqueous medium comprises water and, optionally, one or more water-soluble flavor compounds. In some embodiments thereof, the continuous phase comprises the fatty composition and the dispersed phase comprises an aqueous medium. In some further such embodiments, the continuous phase makes up from 30 weight percent to 99 weight percent of the emulsion, and the dispersed phase makes up from 0.1 weight percent to 50 weight percent of the emulsion.

In a third aspect, the disclosure provides uses of the fatty composition of the first aspect or the emulsion of the second aspect to modify the flavor of a comestible article. In some embodiments, the comestible article is a food product, a pet food product, or a feed product. In some further embodiments, the comestible article is a meat analogue product. In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like.

In some embodiments, the fatty composition or the emulsion are used in the comestible article at a concentration ranging from 0.1 weight percent to 10 weight percent, based on the total weight of the comestible article. In some embodiments, modifying the flavor of the comestible article comprises enhancing the juiciness of the comestible article. In some embodiments, modifying the flavor of the comestible article comprises enhancing the mouthfeel of the comestible article. In some embodiments, modifying the flavor of the comestible article comprises enhancing the mouthcoating of the comestible article. In some embodiments, modifying the flavor of the comestible article comprises increasing the thickness of fluids within the comestible article. In some embodiments, where the comestible article is a meat analogue, the meat analogue is a beef analogue, a poultry analogue, a fish analogue, a pork analogue, or a shellfish analogue, such as a crabmeat analogue, a scallop analogue, or a shrimp analogue.

In a fourth aspect, the disclosure provides methods of modifying a flavor of a comestible article, the method comprising introducing the fatty composition of the first aspect or the emulsion of the second aspect to a comestible article. In some embodiments, the comestible article is a food product, a pet food product, or a feed product. In some further embodiments, the comestible article is a meat analogue product. In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like. In some embodiments, the fatty composition or the emulsion are introduced to the comestible article at a concentration ranging from 0.1 weight percent to 10 weight percent, based on the total weight of the comestible article. In some embodiments, modifying the flavor of the comestible article comprises enhancing the juiciness of the comestible article. In some embodiments, modifying the flavor of the comestible article comprises enhancing the mouthfeel of the comestible article. In some embodiments, modifying the flavor of the comestible article comprises enhancing the mouthcoating of the comestible article. In some embodiments, modifying the flavor of the comestible article comprises increasing the thickness of fluids within the comestible article. In some embodiments, where the comestible article is a meat analogue, the meat analogue is a beef analogue, a poultry analogue, a fish analogue, a pork analogue, or a shellfish analogue, such as a crabmeat analogue, a scallop analogue, or a shrimp analogue.

In a fifth aspect, the disclosure provides uses of the fatty composition of the first aspect or the emulsion of the second aspect to replace animal fats in a comestible article. In some embodiments, the comestible article is a food product, a pet food product, or a feed product. In some further embodiments, the comestible article is a meat analogue product. In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like.

In some embodiments, the fatty composition or the emulsion are used in the comestible article at a concentration ranging from 0.1 weight percent to 10 weight percent, based on the total weight of the comestible article. In some embodiments, where the comestible article is a meat analogue, the meat analogue is a beef analogue, a poultry analogue, a fish analogue, a pork analogue, or a shellfish analogue, such as a crabmeat analogue, a scallop analogue, or a shrimp analogue.

In a sixth aspect, the disclosure provides methods of reducing or eliminating animal fats in a comestible article, the method comprising introducing the fatty composition of the first aspect or the emulsion of the second aspect to a comestible article. In some embodiments, the comestible article is a food product, a pet food product, or a feed product. In some further embodiments, the comestible article is a meat analogue product. In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like. In some embodiments, the fatty composition or the emulsion are introduced to the comestible article at a concentration ranging from 0.1 weight percent to 10 weight percent, based on the total weight of the comestible article. In some embodiments, where the comestible article is a meat analogue, the meat analogue is a beef analogue, a poultry analogue, a fish analogue, a pork analogue, or a shellfish analogue, such as a crabmeat analogue, a scallop analogue, or a shrimp analogue.

In a seventh aspect, the disclosure provides comestible articles, which comprise the fatty composition of the first aspect or the emulsion of the second aspect. In some embodiments, the comestible article is a food product, a pet food product, or a feed product. In some further embodiments, the comestible article is a meat analogue product. In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like. In some embodiments, the fatty composition or the emulsion are present in the comestible article at a concentration ranging from 0.1 weight percent to 10 weight percent, based on the total weight of the comestible article. In some embodiments, modifying the flavor of the comestible article comprises enhancing the juiciness of the comestible article. In some embodiments, modifying the flavor of the comestible article comprises enhancing the mouthfeel of the comestible article. In some embodiments, where the comestible article is a meat analogue, the meat analogue is a beef analogue, a poultry analogue, a fish analogue, a pork analogue, or a shellfish analogue, such as a crabmeat analogue, a scallop analogue, or a shrimp analogue.

In an eighth aspect, the disclosure provides methods of making the emulsion of the second aspect, the method comprising: (a) providing a fatty composition of the first aspect; (b) emulsifying an aqueous medium as the dispersed phase into the fatty composition as the continuous phase at a temperature above the phase transition temperature of the continuous phase to form an emulsified composition, wherein the fatty composition optionally comprises an emulsifier; and (c) cooling the emulsified composition to a temperature below the phase change temperature of the continuous phase.

Other aspects and embodiments of the present disclosure are set forth below in the Detailed Description.

### BRIEF DESCRIPTION OF DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows the total ion intensity of the non-extruded and extruded pea protein isolate samples.

FIG. 2 shows the total ion intensity of the water-in-oil reaction flavor extruded and non-extruded samples.

FIG. 3 shows the total ion intensity of the oil reaction flavor extruded and non-extruded samples.

FIG. 4 shows the droplet size distribution of the emulsion prepared in Example 2 diluted in heated isopropyl myristate (a hydrophobic solvent) and measured by light microscopy.

FIG. 5 shows the measurement of viscoelastic properties while melting the material prepared according to certain embodiments of the present disclosure. G′ represents elastic shear modulus, and G″ represents viscous shear modulus. The measurements were performed with constant amplitude and frequency of oscillation (strain amplitude: 0.3%, and frequency: 0.5 Hz).

FIG. 6 shows the results of strain amplitude sweep experiments, where viscoelastic properties were measured above the melting temperature of the continuous fat phase at 37° C. G′ represents elastic shear modulus, and G″ represents viscous shear modulus. The measurements were performed at a constant frequency of 0.5 Hz while increasing the amplitude of the oscillating shear strain from low to high.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Fatty Compositions

In at least one aspect, the present disclosure provides fatty compositions comprising solid fat particles and a liquid (edible) oil, wherein the solid fat particles are dispersed within the liquid (edible) oil.

The solid fat particles can be comprised of any suitable fat or fat mixture that is generally solid at room temperature, such as at 22° C. The fats in the fat particles can be from any suitable source, such as animal or plant sources.

In some embodiments, the fat particles comprise plant-derived fats. Suitable such plant-derived fats include cocoa butter, palm fat (i.e., solid palm oil), coconut fat (i.e., solid coconut oil), palm kernel fat (i.e., solid palm kernel oil), hydrogenated vegetable oils, or any combinations thereof. In some embodiments, the plant-derived fats include cocoa butter. In some such embodiments, the fat particles comprise at least 75% by weight, or at least 80% by weight, or at least 85% by weight, or at least 90% by weight, or at least 95% by weight, or at least 97% by weight, or at least 99% by weight, of plant-derived fats, based on the total weight of solid fat particles in the fatty composition.

In some other embodiments, the fat particles comprise animal-derived fats. Suitable such animal derived fats include butter, lard, tallow, or any combination thereof. In some such embodiments, the fat particles comprise no more than 25% by weight, or no more than 20% by weight, or no more than 15% by weight, or no more than 10% by weight, or no more than 5% by weight, or no more than 3% by weight, or no more than 1% by weight, of animal-derived fats, based on the total weight of solid fat particles in the fatty composition.

In general, the fats that make up the solid fat particles are triglycerides, but may include certain amounts of diglycerides or monoglycerides. Note, as used herein, the term “fat” refers to fatty acid glycerides, which are in a solid state at a given temperature, such as room temperature (22° C.). The fats that make up the solid fat particles comprise at least 75% by weight, or at least 80% by weight, or at least 85% by weight, or at least 90% by weight, or at least 95% by weight, or at least 97% by weight, of triglycerides, based on the total weight of fatty acid glycerides in the solid fat particles. The fatty acids that make up the fatty acid glycerides in the solid fat particles can be any suitable mixture of saturated and unsaturated fatty acids. In some embodiments, the fats that make up the solid fatty particles have an iodine number ranging from 1 to 75, or from 2 to 65, or from 5 to 55.

The solid fat particles can have any suitable melting point. In some embodiments, the solid fat particles have a melting point of at least 30° C., or at least 35° C., or at least 40° C. In some further embodiments, the solid fat particles have a melting point of no more than 80° C.

In some embodiments, the solid fat particles comprise an edible wax. Non-limiting examples of edible waxes include hydrogenated soy fat, palm fat, coconut fat, cocoa butter, carnauba wax, rice bran wax, shea butter, and mixture thereof. In some embodiments, the edible wax is an animal fat having higher melting point fat fractions such as palm or shea olein and mixtures thereof.

As noted above, the fatty composition also comprises a liquid (edible) oil into which the solid fat particles are dispersed. Any suitable can be used, so long as the oil is generally a liquid at room temperature (e.g., 22° C.), such as an animal oil, a fish oil, a vegetable oil, an algal oil, or any combination thereof. In some embodiments, the liquid oil is a plant-derived oil. In some other embodiments, the oil is not a plant-derived oil. Examples of liquid oils include sunflower oil, rapeseed or canola oil, soybean oil, palm oil, coconut oil, groundnut (peanut) oil, palm kernel oil, olive oil, cottonseed oil, sesame oil, linseed oil, an algal oil, a marine oil, avocado oil, argan oil, and any mixtures thereof. In some embodiments, the liquid oil comprises medium chain triglyceride oil (MCT) oil, soybean oil, cottonseed oil, peanut oil, sesame oil, corn oil, sunflower oil, canola oil, safflower oil, avocado oil, olive oil, argan oil, or any mixtures thereof.

In general, the liquid oil and the solid fatty particles will have a difference in their melting point. In general, the liquid oil will have a melting point of no more than 25° C., or no more than 20° C., or no more than 15° C., or no more than 10° C., or no more than 8° C., or no more than 5° C.

In some embodiments, the difference in melting between the higher melting point of the solid fat particles and the lower melting points of the liquid oil ranges from 5° C. to 105° C., or from 8° C. to 90° C., or from 10° C. to 80° C., or from 12° C. to 70° C., or from 15° C. to 60° C.

The solid fat particles and the liquid oil can be present in the fatty composition in any suitable relative amounts, so long as there is enough liquid oil to disperse the solid fatty particles at around room temperature. In some embodiments, weight ratio of liquid oil to solid fat particles in the fatty composition ranges from 30:70 to 99:1, or from 40:60 to 98:2, or from 55:45 to 97:3, or from 60:40 to 95:5, or from 70:30 to 93:7, or from 72:28 to 92:8.

In some embodiments, it may be desirable that the fatty composition be substantially free of animal fats or oils. Thus, in some embodiments, the fatty composition comprises no more than 5% by weight, or no more than 3% by weight, or no more than 1% by weight, or no more than 0.5% by weight, or no more than 0.3% by weight, or no more than 0.1% by weight, of animal-derived fats or oils, based on the total weight of the fatty composition.

In some embodiments, it may be desirable that the fatty composition be substantially free of fats or oils derived from genetically modified plants (GMO-derived fats or oils). Thus, in some embodiments, the fatty composition comprises no more than 5% by weight, or no more than 3% by weight, or no more than 1% by weight, or no more than 0.5% by weight, or no more than 0.3% by weight, or no more than 0.1% by weight, of GMO-derived fats or oils, based on the total weight of the fatty composition.

In some embodiments, the fatty composition comprises an emulsifier. When present, the emulsifier can be present at any suitable concentration. In some embodiments, the concentration of emulsifier in the fatty composition ranges from 0.2% by weight to 35% by weight, or from 0.3% by weight to 20% by weight, or from 0.4% by weight to 15% by weight, or from 0.5% by weight to 10% by weight, or from 0.6% by weight to 8% by weight, of emulsifier, based on the total weight of the fatty composition.

In general, emulsifiers are amphiphilic molecules that concentrate at the interface between two phases and modify the properties of that interface. Suitable non-limiting examples of emulsifiers are described in MCCUTCHEON'S EMULSIFIERS & DETERGENTS OR THE INDUSTRIAL SURFACTANTS HANDBOOK. Some specific non-limiting examples of emulsifiers include lecithins, polyoxyethene, stearates, polysorbate 20, sorbitan derivatives (polysorbate 20, polysorbate 80, polysorbate 40, polysorbate 60, and polysorbate 65), mixed ammonium salts of phosphorylated glycerides, enzymatically hydrolyzed carboxymethyl-cellulose, mono- and diglycerides of fatty acids, esters of mono- and diglycerides of fatty acids (such as acetic acid esters, lactic acid esters, citric acid esters, tartaric acid esters, mono- and diacetyl tartaric acid esters, mixed acetic and tartaric acid esters), succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propanol, thermally oxidized soya bean oil interacted with mono- and diglycerides of fatty acids, sodium stearoyl lactylate, calcium stearoyl lactylate, stearyl tartrate, stearyl citrate, sodium stearoyl fumarate, calcium stearoyl fumarate, sodium dodecyl sulfate, ethoxylated mono- and di-glycerides, methyl glucoside-coconut oil ester, sorbitan monostearate, sorbitan tristearate, sorbitan monolaurate, sorbitan monooleate, sorbitan monopalmitate, sorbitan trioleate, and combinations thereof.

In some embodiments, the emulsifier comprises lecithins (such as mixtures of glycerophospholipids, including phosphatidylcholine PC, phosphatidylethanolamine PE, phosphatidylinositol PI, and phosphatidic acid PA) with different triglyceride content (pure lecithins or deoiled lecithins, different ratio PC-to-PE-to-PI). Such lecithins can be used in any suitable form, including in the form of oily paste or powders. Lecithins are commercially available from a number of suppliers including Cargill (brands EMELPUR, EMULTOP, LECIMULTHIN, EPIKURON), Archer Daniels Midland (brand ULTRALEC, ADLEC), Solae (brand SOLEC), and Bunge (brand BUNGEMAXX).

Suitable emulsifiers can be characterized according to their hydrophilic-lipophilic balance (HLB), measured on an empirical scale set forth in Griffin, J. COSMET. CHEM., vol. 1, p. 311 (1949). This scale ranges from 0 to 20, with 0 for a completely lipophilic molecule and 20 for a completely hydrophilic molecule. The function of surfactants can be generally described by their HLB number. Defoaming surfactants have an HLB range of 1-3. Water-in-oil emulsifiers have an HLB range of 3-6. Wetting agents have an HLB range of 7-9. Oil-in-water emulsifiers have an HLB range of 8-18. Detergents have an HLB range of 13-15. Solubilizers have an HLB range of 15-18.

In some embodiments, the emulsifier present in the fatty composition has an HLB value of no more than 10, of no more than 9, or of no more than 8, or of no more than 7, or of no more than 6. In some embodiments, the emulsifier present in the fatty composition has an HLB value ranging from 3 to 9, or from 4 to 9, or from 5 to 9, or from 6 to 9, or from 7 to 9, or from 3 to 8, or from 3 to 7, or from 3 to 6. Such emulsifiers may be referred to as low-HLB emulsifiers.

Non-limiting examples of the low-HLB emulsifiers suitable to form water-in-oil emulsion include, alcohol alkoxylates, alkylamine alkoxylates, polyetheramine alkoxylates, ethylene oxide/propylene oxide block polymers, phosphate esters, alkyl sulfates, alkyl ether sulfates, alkyl and alkylbenzene sulfonates, fatty acid esters, fatty oil alkoxylates, saccharide derivatives, sorbitan derivatives, alkyl phenol alkoxylates, arylphenol alkoxylates, sulphosuccinates, sulphosuccinamates, and any combinations thereof. The emulsifiers can be nonionic, anionic, cationic or zwitterionic. In some embodiments, the emulsifiers are suitable for use in foods, pet foods, or feed products, including, but not limited to fatty acid esters, saccharide derivatives, sorbitan derivatives, especially sorbitan esters, mono/diglyceride, citric acid esters, lecithin and other phospholipids, and combinations thereof. Commercial examples of such low-HLB emulsifiers include, but are not limited to, the DIMODAN emulsifiers (distilled monoglycerides) available from DuPont-Danisco, CITREM (citric acid esters of mono- and diglycerides) available from Paalsgard, SOLEC (soy lecithin) available from DuPont Nutrition, or GRINSTED STS/SMS (sorbitan esters) also available from DuPont Nutrition.

In some embodiments thereof, the fatty composition comprises fat-soluble flavor compounds, such as fat-soluble aroma compounds. Such fat-soluble flavor compounds can be present in the fatty composition in any suitable amount. For example, in some embodiments, the fat-soluble flavor compounds make up from 0.1% by weight to 80% by weight, or from 1% by weight or from 60% by weight, of the fatty composition, based on the total weight of the fatty composition.

Any suitable fat-soluble flavor compounds can be used, according to those known in the relevant art. Flavor compounds are discussed in further detail below.

### Emulsions of Fatty Compositions

In another aspect, the disclosure provides emulsions comprising a continuous phase and a dispersed phase, wherein one of the continuous phase or the dispersed phase comprises the fatty composition of the foregoing aspect and any embodiments thereof, and the other of the continuous phase or the dispersed phase comprises an aqueous medium.

In some embodiments, the continuous phase comprises the fatty composition and the dispersed phase comprises the aqueous medium. The fatty composition can have any suitable characteristics, according to the embodiments set forth in the preceding section of this disclosure. The aqueous medium comprises water. For example, in some embodiments, water makes up at least 75% by weight, or at least 80% by weight, or at least 85% by weight, or at least 90% by weight, or at least 95% by weight, or at least 97% by weight, or at least 99% by weight, of the aqueous medium, based on the total weight of aqueous medium. In some further embodiments, the aqueous medium comprises water-soluble flavor compounds.

AS used herein, the term “emulsion” refers to a mixture of two or more liquids that are normally immiscible (i.e., not mixable). In an emulsion, one liquid (the dispersed phase) is dispersed in the other (the continuous phase). In certain instances, one of the phases is a hydrophobic or lipophilic phase, and the other phase is a hydrophilic phase. In certain embodiments disclosed herein, the emulsion is a water-in oil emulsions, which comprises a continuous hydrophobic (i.e., lipophilic) phase in which the hydrophilic phase is dispersed.

The emulsion can be any type of emulsion. For example, in some embodiments, the emulsion is a macroemulsion, a microemulsion, or a nanoemulsion.

The emulsions disclosed herein may be prepared by any suitable procedure. For example, in some embodiments, the emulsion is prepared by applying mechanical force to emulsify the disperse phase droplets, such as by mechanical mixing with a high shear blender, a colloidal mill, an impeller mixer, or by the use of a high-pressure homogenizer. In some embodiments, such emulsions are prepared by ultrasound processing, by phase inversion emulsification, by membrane emulsification, or by emulsification using microfluidic channels.

The emulsion can have any suitable weight ratio between the continuous phase and the dispersed phase. For example, in some embodiments, the continuous phase makes up from 30% by weight to 99% by weight, or from 35% by weight to 98% by weight; or from 38% by weight to 97% by weight, or from 40% by weight to 95% by weight, or from 45% by weight to 93% by weight, of the emulsion, based on the total weight of the emulsion. In certain related embodiments, the dispersed phase makes up from 0.1% by weight to 50% by weight, or from 3% by weight to 45% by weight, or from 5% by weight to 40% by weight, or from 8% by weight to 30% by weight, of the emulsion, based on the total weight of the emulsion.

In some embodiments, the aqueous medium comprises soluble fiber. In such embodiments, the soluble fiber can be present in any suitable concentration. For example, in some embodiments, the soluble fiber is present in the aqueous medium at a concentration ranging from 0.1% by weight to 5% by weight, or from 1% by weight to 2% by weight, based on the total weight of the aqueous medium. In some embodiments, the soluble fiber is present at a concentration suitable for forming a hydrogel when the emulsion is heated above room temperatures, such as standard temperatures for cooking meat.

As used herein, the term “soluble fiber” refers to polysaccharides that are soluble in water, such as according to the method set forth in Prosky et al, J. ASSOC. ANAL. CHEM., vol. 70(5), p. 1017 (1988). Such fibers can include fibers from a variety of sources. Some non-limiting examples of suitable fibers include fruit fiber, grain fiber, natural soluble fiber, and synthetic soluble fiber. Natural soluble fiber includes soluble corn fiber, maltodextrin, acacia, and hydrolyzed guar gum. Synthetic soluble fibers include polydextrose, modified food starch, and the like. Food grade sources of soluble fiber useful in embodiments of the present disclosure include inulin, corn fiber, barley, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potato fiber, konjac vegetable fiber, psyllium fiber (e.g., from seed husks of planago ovate), psyllium husk fiber, liquid agave fiber, rice bran fiber, oat sprout fibers, amaranth sprout fiber, lentil flour fiber, grape seed fiber, apple fiber, blueberry fiber, cranberry fiber, fig fiber, ciranda power fiber, carob powder fiber, milled prune fiber, mango fiber, orange fiber, orange pulp, strawberry fiber, carrageenan hydrocolloid, derivatives of eucheuma cottonnil seaweed, cottonseed fiber, soya fiber, kiwi fiber, acacia gum fiber, bamboo fiber, chia fiber, potato fiber, potato starch, pectin (carbohydrate) fiber, hydrolyzed guar gum, carrot fiber, soy fiber, chicory root fiber, oat fiber, wheat fiber, tomato fiber, polydextrose fiber, refined corn starch syrup, isomalto-oligosaccharide mixtures, soluble dextrin, mixtures of citrus bioflavonoids, cell-wall broken nutritional yeast, lipophilic fibers, prune juice, derivatives from larch trees, olygose fiber, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

In some embodiments, the aqueous medium comprises water-soluble flavor compounds. Any suitable water-soluble flavor compounds can be used, according to those known in the relevant art. Flavor compounds are discussed in further detail below.

In some cases, it may be desirable to describe the resulting emulsion in terms of particular physical characteristics. For example, in some embodiments, the emulsion is a water-in-oil emulsion having an elastic shear modulus G′ (0.3%, 0.5 Hz) higher than its viscous shear modulus G″(0.3%, 0.5 Hz). Using this notation, the numbers provided in brackets refer to the strain amplitude given in percent values, and the frequency of the oscillatory shearing, meaning that values given refer to the shear modulus measured using shear oscillations performed at a frequency of 0.5 Hz and a strain amplitude of 0.3%. The elastic shear modulus represents the elastic behavior of a material for a given frequency and strain amplitude, and is conventionally written as G′ and measured in units of Pascal (Pa). The viscous shear modulus represents the viscous behavior of a material for a given frequency and strain amplitude, and is conventionally written as G″ and also measured in units of Pascal (Pa). These characteristic values are, for example, defined in R. G. Larson, THE STRUCTURE AND RHEOLOGY COMPLEX FLUIDS (1998) or F. A. Morrison, UNDERSTANDING RHEOLOGY (2001).

These viscoelastic properties are measured during dynamic tests under oscillating shear strains (small deformations) performed at a constant temperature or between range of temperatures, for example at temperatures ranging from 4° C. to 80° C., and at a constant frequency (i.e., 0.5 Hz) or a frequency range on a rheometer (for example, a Model DHR-2, TA Instruments) under a torsional/shear strain (i.e., a sinusoidally varying shear strain with a strain amplitude of 0.3% and a frequency of 0.5 Hz), or a range of torsional/shear strains, for example testing a range of oscillatory shear strains with amplitudes ranging from 0.1% to 100%, for example, in cone-plate geometry (for example with a 40 mm diameter cone/plate geometry and a 2 degree cone angle). Such methods are further described in P. Fischer et al., “Rheology of Food Materials”, in CURRENT OPINION IN COLLOID & INTERFACE SCIENCE, vol. 16(1), pp. 36-40 (2011). For example, G′ (0.3%, 0.5 Hz) is the elastic shear modulus of a material, measured at a frequency of 0.5 Hz and at a torsional/shear stress of 0.3%, for a temperature from 5° C. to 80° C. G′ (18° C., 0.5 Hz) is the elastic shear modulus of a material, measured at a frequency of 0.5 Hz and at a temperature of 18° C., for any torsional/shear stress from 0.1% to 100%. G″ (0.3%, 0.5 Hz) is the viscous shear modulus of a material, measured at a frequency of 0.5 Hz and at a torsional/shear stress of 0.3%, for any temperature from 5° C. to 80° C.

In some embodiments, the emulsions disclosed herein have an elastic shear modulus G′ (0.5 Hz, 37° C.) higher than the viscous shear modulus G″ (0.5 Hz, 37° C.) at a shear strain lower than 8%, or lower than 7%, or lower than 5%. In some embodiments, the emulsions disclosed herein have a ratio G′ (0.3%, 0.5 Hz)/G′ (0.3%, 0.5 Hz) of no more than 20, or no more than 15, or no more than 10, or no more than 5, or no more than 3, or no more than 2, or no more than 1, or no more than 0.5. In some embodiments, the emulsions disclosed herein have a ratio G′ (0.3%, 0.5 Hz)/G′ (0.3%, 0.5 Hz) of at least 0.001, or at least 0.01, or at least 0.05. In some embodiments, the emulsions disclosed herein have a ratio G′/G″ (0.5 Hz, 18° C.) of no more than 1. In some embodiments, the emulsions disclosed herein have a ratio G′/G″ (0.5 Hz, 18° C.) of at least 0.01.

The dispersed phase generally forms drops in the emulsion. The drop size can be any suitable size, depending on various factors. In some embodiments, the emulsions have a drop size having an average diameter of ranging from 0.1 μm to 30 μm, or from 0.8 μm to 20 μm, or from 2 μm to 10 μm. The drop size can be measured via any well-established method that allows measurements which are accurate within an experimental error of 5% at the most and preferably below 1%. Suitable well-established methods use light microscopy (for example, R. J. Hunter, INTRODUCTION TO MODERN COLLOID SCIENCE (1994)). In some instances, the drop size distribution can be measured by image analysis using the software of the light microscope (Nikon Eclipse Software) of a sample diluted in heated isopropyl myristate. The term “average” refers to an arithmetic mean.

The emulsions disclosed herein can, in certain embodiments, contain other additives, adjuvants, and the like, that are commonly included in food products, pet food products, and feed products. For example, the emulsions disclosed herein can, in certain embodiments, comprise any additional ingredients or combination of ingredients as are commonly used in comestible products, including, but not limited to:

acids, including, for example citric acid, phosphoric acid, ascorbic acid, sodium acid sulfate, lactic acid, or tartaric acid;

bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);

coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;

preservatives, including, for example sodium benzoate, potassium benzoate, potassium sorbate, sodium metabisulfate, sorbic acid, or benzoic acid;

antioxidants including, for example ascorbic acid, calcium disodium EDTA, alpha tocopherols, mixed tocopherols, rosemary extract, grape seed extract, resveratrol, or sodium hexametaphosphate;

vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;

clouding agents, including, for example ester gun, brominated vegetable oil (BVO), or sucrose acetate isobutyrate (SAIB);

buffers, including, for example sodium citrate, potassium citrate, or salt;

flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or

starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

One example of an additional ingredient includes free fatty acids. Suitable examples include stearic acid, palmitic acid, myristic acid, lauric acid, capric acid, caprylic acid, and the like. These free fatty acids can be present at any suitable concentration. For example, in some embodiments, free fatty acids are present at a concentration ranging from 3% by weight to 20% by weight, or from 5% by weight to 18% by weight, or from 7% by weight to 16% by weight, in the emulsion, based on the total weight of the emulsion.

Other acids can also be present, for example, to help adjust the pH of the final product. Suitable acids for this purpose include comestible acids, such as lactic acid, citric acid, and combinations thereof. Such acids can be present at any concentration. For example, in some embodiments, free fatty acids are present at a concentration ranging from 0.2% by weight to 3.0% by weight, or from 0.5% by weight to 2.0% by weight, or from 0.7% by weight to 1.8% by weight, in the emulsion, based on the total weight of the emulsion.

### Flavor Compounds

As noted above, both the fatty composition and the aqueous medium can, in certain embodiments, comprise fat-soluble and water-soluble flavour compounds, respectively. AS used herein, a “flavor” or “flavor compound” that are added, either alone or in combination with other such compounds, to a comestible composition to impart, improve, or modify its organoleptic properties, in particular its flavor, taste, or aroma. Such compounds may be natural or synthetic. Many such flavor compounds are listed in reference texts such as S. Arctander, PERFUME AND FLAVOR CHEMICALS (1969), or its more recent editions, or in other works such as FENAROLI'S HANDBOOK OF FLAVOR INGREDIENTS (1975) or M. B. Jacobs, SYNTHETIC FOOD ADJUNCTS (1947). Solvents and adjuvants of current use for the preparation of a flavoring formulation are also well known in the industry. These substances are well known to the person skilled in the art of flavoring or aromatizing foods and consumer products. Suitable examples of flavor additives include compounds such as methylfuranthiol, namely, 2-methyl-3-furanthiol.

Non-limiting examples of flavor compounds that may be used in the fatty compositions or emulsions disclosed herein include organic salts, inorganic salts, organic acids, sugars, amino acids and their salts (such as glutamates or aspartates), ribonucleotides, and sources thereof, and any combination of the foregoing.

Sweeteners are a common example of flavour compounds. Thus, in some embodiments, the fatty compositions or emulsions disclosed herein comprise an additional sweetener, such as a caloric sugar, such as sucrose, glucose, fructose (e.g., in the form of high-fructose corn syrup), or any combination thereof. In some embodiments, the sweetening composition comprises one or more rebaudiosides. In some embodiments, the fatty compositions or emulsions disclosed herein comprises one or more high-intensity artificial sweeteners, such as acesulfame potassium, sucralose, aspartame, cyclamate, neotame, and the like. In some other embodiments, the fatty compositions or emulsions disclosed herein comprise one or more low-calorie carbohydrates or sugar alcohols, such as allulose, xylitol, erythritol, and the like. In some other embodiments, the fatty compositions or emulsions disclosed herein comprise mogrosides, for example, as monk fruit juice or extract, or as one or more of mogroside III, mogroside IV, mogroside V, siamenoside I, isomogroside V, mogroside IV_{E}, isomogroside IV_{E}, isomogroside IV, mogroside III_{E}, 11-oxomogroside V, the 1,6-alpha isomer of siamenoside I, and any combinations thereof. Additional mogroside compounds that may be suitably included in the sweetening composition are described in U.S. Patent Application Publication No. 2017/0119032.

Various other sweeteners may also be included in the fatty compositions or emulsions disclosed herein. Non-limiting examples include D-psicose, L-ribose, D-tagatose, L-glucose, L-fucose, L-arbinose, D-turanose, D-leucrose, isomalt, lactitol, mannitol, sorbitol, maltodextrin, saccharin, alitame, cyclamic acid, tagatose, maltose, galactose, mannose, lactose, D-tryptophan, glycine, maltitol, lactitol, isomalt, hydrogenated starch hydrolyzate (HSH), chemically modified mogrosides (such as glucosylated mogrosides), carrelame and other guanidine-based sweeteners, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bemadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

The fatty compositions or emulsions set forth according to any of the foregoing embodiments, also include, in certain embodiments, one or more additional flavor-modifying compounds, such as compounds that enhance sweetness (e.g., hesperetin, naringenin, phloretin, rhoifolin, etc.), compounds that block or mask bitterness, compounds that enhance umami, compounds that reduce sourness or licorice taste, compounds that enhance saltiness, compounds that enhance a cooling effect, compounds that enhance mouthfeel, or any combinations of the foregoing.

In some embodiments, fatty compositions or emulsions disclosed herein comprise one or more sweetness enhancing compounds. Such sweetness enhancing compounds include, but are not limited to, naturally derived compounds, such as hesperitin, naringenin, rhoifolin, phloretin, glucosylated natural steviol glycosides, licorice-derived glucuronates, aromadendrin-3-O-acetate, or other like flavonols, or flavonoids, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. Some suitable examples include: 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]-thiadiazin-5-yl)oxy)-2-methyl-propan-2-yl)-isonicotinamide, or any combination thereof.

In some further embodiments, fatty compositions or emulsions disclosed herein comprise one or more umami or kokumi enhancing compounds. Such umami enhancing compounds include, but are not limited to, naturally derived compounds, such as ericamide, or synthetic compounds, such as any compounds set forth in U.S. Pat. Nos. 8,735,081; 8,124,121; and 8,968,708.

In some further embodiments, fatty compositions or emulsions disclosed herein comprise one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, fatty compositions or emulsions disclosed herein comprise one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759, and in PCT Publication No. WO 2020/033669.

In some further embodiments, fatty compositions or emulsions disclosed herein comprise one or more mouthfeel modifying compounds. Such mouthfeel modifying compounds include, but are not limited to, tannins, cellulosic materials, bamboo powder, and the like.

In some further embodiments, fatty compositions or emulsions disclosed herein comprise one or more flavor masking compounds. Such flavor masking compounds include, but are not limited to, cellulosic materials, materials extracted from fungus, materials extracted from plants, citric acid, carbonic acid (or carbonates), and the like.

The flavor composition may be water soluble or oil soluble. Depending on its solubility, the flavor composition may be in the dispersed phase and/or the continuous phase. Solubility of a flavor composition can be evaluated according to dissolution in water or oil notably using the partition coefficient (P) (Log P value).

In some instances, the flavouring compounds can be compounds that simulate the flavour properties of blood, such as the blood typically found in red meat products, such as beef, lamb, pork, and the like. Such flavour compounds or combinations of flavour compounds can be used in imitation burgers, and the like. Such flavour compounds are often plant-based metalloproteins, which are formed from proteins and iron to mimic heme.

### Methods of Preparation

In another aspect, the disclosure provides methods of making the emulsion of the previous aspect (and any embodiments thereof), the method comprising: (a) providing a fatty composition (as described in any of the preceding embodiments); (b) emulsifying an aqueous medium (according to any of the preceding embodiments) as the dispersed phase into the fatty composition as the continuous phase at a temperature above the phase transition temperature of the continuous phase to form an emulsified composition, wherein the fatty composition optionally comprises an emulsifier; and (c) cooling the emulsified composition to a temperature below the phase change temperature of the continuous phase.

The term “phase transition temperature” means the temperature at which the medium (or the continuous phase) changes, for example, from solid to liquid when it is referred to melting temperature or melting point.

In some embodiments, the method comprises a preheating step of heating the fatty composition to a temperature ranging from 80° C. to 150° C., or to a temperature ranging from 95° C. to 120° C.

In some embodiments, the method comprises a preheating step of heating the aqueous medium to temperature ranging from 60° C. to 100° C., or to a temperature ranging from 70° C. to 90° C.

In some embodiments, the cooling step (c) is carried out by reducing temperature of the emulsion at a rate ranging from 5° C./hour to 30° C./hour, or at a rate ranging from 10° C./hour to 25° C./hour, or at a rate ranging from 12° C./hour to 15° C./hour.

### Uses, Methods, Comestible Articles

In another aspect, the disclosure provides uses of the fatty composition (as described in any of the preceding embodiments) or the emulsion (as described in any of the preceding embodiments) to modify the flavor of a comestible article. In some embodiments, modifying the flavor of the comestible article comprises enhancing the juiciness of the comestible article. In some embodiments, modifying the flavor of the comestible article comprises enhancing the mouthfeel of the comestible article. In some embodiments, modifying the flavor of the comestible article comprises enhancing the mouthcoating of the comestible article. In some embodiments, modifying the flavor of the comestible article comprises increasing the thickness of fluids within the comestible article. Note that the expression “enhancing the juiciness” refers to the improvement of the sensory attributes of juiciness in the comestible article.

In a related aspect, the disclosure provides methods of modifying a flavor of a comestible article, the method comprising introducing the fatty composition (as described in any of the preceding embodiments) or the emulsion (as described in any of the preceding embodiments) to a comestible article. In some embodiments, modifying the flavor of the comestible article comprises enhancing the juiciness of the comestible article. In some embodiments, modifying the flavor of the comestible article comprises enhancing the mouthfeel of the comestible article. In some embodiments, modifying the flavor of the comestible article comprises enhancing the mouthcoating of the comestible article. In some embodiments, modifying the flavor of the comestible article comprises increasing the thickness of fluids within the comestible article. Note that the expression “enhancing the juiciness” refers to the improvement of the sensory attributes of juiciness in the comestible article.

In another related aspect, the disclosure provides uses of the fatty composition (as described in any of the preceding embodiments) or the emulsion (as described in any of the preceding embodiments) to replace animal fats in a comestible article.

In another related aspect, the disclosure provides methods of reducing or eliminating animal fats in a comestible article, the method comprising introducing the fatty composition (as described in any of the preceding embodiments) or the emulsion of (as described in any of the preceding embodiments) to a comestible article.

In another related aspect, the disclosure provides comestible articles, which comprise the fatty composition (as described in any of the preceding embodiments) or the emulsion (as described in any of the preceding embodiments).

The foregoing aspects are specifically directed to comestible articles or directed to uses or methods that concern comestible articles. Such comestible articles can be any edible product, such as a food product, a pet food product, or a feed product.

In some further embodiments, the comestible article is a meat analogue product. The meat analogue is a non-meat product that, when eaten, is intended to simulate the sensory experience of eating meat. In some embodiments, the meat analogue product is a beef analogue product, a poultry analogue product, a fish analogue product, a pork analogue product, or a shellfish analogue product, such as a crabmeat analogue product, a scallop analogue product, or a shrimp analogue product. Non-limiting examples include vegetarian burgers, sausage, imitation chicken nuggets, imitation deli meat, imitation poultry, imitation beef, imitation pork, imitation ham, imitation fresh sausage or imitation raw meat preparations, imitation cured meat products, and imitation reformed meat.

The fatty composition (of any of the preceding embodiments) or emulsion (of any of the preceding embodiments) can be present in the comestible article at any suitable concentration. In some embodiments, the fatty composition or the emulsion are present in the comestible article at a concentration ranging from 0.01% by weight to 10% by weight, or from 0.1% by weight to 10% by weight, or from 0.5% by weight to 5% by weight, based on the total weight of the comestible article.

The fatty composition or emulsion can be introduced to the comestible article in any suitable manner. In some embodiments, for example, the fatty composition or the emulsion is added to the comestible article by injection, vacuum tumbling (optionally with a carrier material), or mixing with the food prior to its preparation (for example, before its baking, its extrusion, and the like).

As noted above, one goal of using the fatty compositions or the emulsions described herein is to allow one to reduce the amount of animal products, such as animal fats, in the comestible article. In some embodiments, the comestible article comprises no more than 1% by weight, or no more than 0.5% by weight, or no more than 0.1% by weight, or no more than 0.05% by weight, or no more than 0.01% by weight of animal-derived fatty acid glycerides.

Note that the meat analogue products may be contained within or mixed with other non-meat products. Thus, the presently disclosed flavored products (e.g., meat analogues) can be included in pasta sauces, in soups, in marinades or pastes, notably used for fish or meat products, in confectionery products, and in dairy products.

In some embodiments, the comestible article comprises one or more plant proteins, such as pea protein, soy protein, nut protein, and the like. In some further embodiments, the comestible article comprises one or more plant fibers, such as bamboo fiber, psyllium fiber, and the like. In some embodiments, the fatty composition or the emulsion are used in the comestible article at a concentration ranging from 0.1 weight percent to 10 weight percent, based on the total weight of the comestible article.

In some embodiments, the flavored product further comprises proteins, such as proteins derived from plants, animals, eggs, dairy products, and the like. In some embodiments, the proteins comprise at least 75% by weight, or at least 80% by weight, or at least 85% by weight, or at least 90% by weight, or at least 95% by weight, or at least 97% by weight, or at least 99% by weight, of plant-derived protein, based on the total weight of protein in the comestible article. Any suitable plant protein or blend of plant proteins can be used. Non-limiting examples include soy protein, corn protein, pea protein, canola protein, sunflower protein, sorghum protein, rice protein, amaranth protein, potato protein, tapioca protein, arrowroot protein, chickpeas protein, lupin protein, wheat protein, oat protein, rye protein, barley protein, bean or lentil protein, protein from fermented soy products (such as tofu, tempeh, etc.), peanut protein, cashew protein, nut protein (such as almond protein, walnut protein, and the like), quinoa protein, mycoprotein, chia protein, hemp protein, pumpkin seed protein, spirulina protein, broccoli protein, kale protein, brussels sprout protein, and any mixtures thereof. In some embodiments, the proteins comprise pea protein.

The comestible article can also comprise fiber or blends of fiber. In general, such fiber is derived from plant materials. In general, plant-based fibers are mainly composed of non-starch polysaccharides and other plant components such as cellulose, resistant starch, resistant dextrins, inulin, lignins, chitins (in fungi), pectins, beta-glucans, and various oligosaccharides. Non-limiting examples of suitable plant sources for fiber include legumes (peas, soybeans, lupins, and other beans), oats, rye, chia, barley, fruit (figs, avocados, plums, prunes, berries, bananas, apples, quinces, kiwi, grapes, tomatoes, and pears), vegetables (broccoli, carrots, green beans, cauliflower, zucchini, celery, nopal, and artickokes), root tubers/vegetables (sweet potatoes and onions), psyllium seed husks, flax seeds, nuts (almonds), whole grains, wheat bran, corn bran, seeds, potato skins, lignans, and any combinations thereof.

Due to its high stability to shear and temperature of the emulsions disclosed herein, the flavored emulsion of the invention is particularly suitable for extruded and/or baked food, pet-food or feed products more particularly comprising animal and/or vegetable proteins. In some cases, the extruded and/or baked food, pet-food or feed products may be selected among meat- and/or fish-based food or analogue and mixtures thereof (in other words, meat-based food and/or fish-based food or meat analogue or fish analogue and mixtures thereof); extruded and/or baked food, meat analogue or extruded and/or baked food fish analogue are preferred. Non-limiting examples of extruded and/or baked food, pet-food or feed products are snack products or extruded vegetable proteins with the aim to texture the protein from which meat analogous (e.g. burgers) are prepared from. The flavored emulsion can be added pre-extrusion or after extrusion to either, the non-extruded vegetable protein isolate/concentrate or to the textured vegetable protein from which a burger or nugget (etc.) can be formed.

The fatty composition or emulsions disclosed herein can be used in a wide variety of edible end-products. End-products are more particularly a food, pet-food, or feed product. The fatty composition or emulsions disclosed herein are particularly advantageous for vegetarian meat analogues or meat replacers, vegetarian burger, sausages, patties, imitation chicken nuggets, and the like. Meat, for the purpose of the present disclosure, encompasses red meat (such as beef, pork, mutton, lamb, and venison) and poultry (such as chicken, turkey, goose and duck), as well as fish and shellfish. In some embodiments, the comestible article is a beef analogue, a poultry analogue, or a pork analogue.

Due to the resistance to shearing and high temperatures, the emulsions disclosed herein can also be of particular interest in the following examples of products:
Baked goods (e.g. bread, dry biscuits, cakes, other baked goods),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices, frozen desserts)
Dairy analogues (imitation dairy products) containing non-dairy ingredients (plant-based proteins, vegetable fats),
Confectionary products (e.g. chewing gum, hard and soft candy),
Chocolate and compound coatings,
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).
Extended meat products (e.g. meat patties, sausages, chili, salisbury steaks, pizza toppings, meatballs, ground meat, bolognas, chicken nuggets, pork frankfurters, beef)

### Definitions and Interpretive Notes

Unless stated otherwise, percentages (%) are meant to designate a percentage by weight of a composition.

It should be understood that the total amount of ingredients in the composition or emulsion is 100%.

Unless specified otherwise, numerical ranges expressed in the format “from x to y” are understood to include x and y. When for a specific feature multiple preferred ranges are described in the format “from x to y,” it is understood that all ranges combining the different endpoints are also contemplated.

The term “comprise” or “comprising”, for the purpose of the present invention is intended to mean “including”. It is not intended to mean, “consisting only of”.

### EXAMPLES

### Example 1

### Preparation of a Water-In-Oil Emulsion Comprising a Flavor Composition in the Dispersed Phase

A quantity of 143 g of an edible oil (MCT oil, see Table 1) was heated to a temperature of 100° C. in a reaction vessel placed in a hot water bath. 14.2 g of a solid fat particles F (Hydrogenated Soy Oil) were added to the heated oil phase, thereby melting the particles.

9.6 g of a 50:50 w/w an emulsifier blend of Dimodan HP and Citrem Liq K was added to this heated oil mixture phase 0 (continuous phase). All these steps were performed while stirring with an impeller stirrer at a slow stirring speed of 100 rpm.

An aqueous droplet phase A (Fatty Juicy Flavor (water soluble flavor)) was separately pre-heated to a temperature of 80° C., avoiding boiling. The stirring speed of the impeller stirrer was then increased to 3000 rpm and 33.4 g of the water phase A was added an approximate addition rate of 2 milliliters per second, thereby emulsifying the water droplets phase A into the heated oil phase 0. This liquid pre-emulsion was left to stir for two minutes at the elevated stirring speed.

The temperature of the water bath was then reduced to 10° C. over the course of 30 minutes with the stirrer mixing at a slower speed of 200 rpm to obtain the final water-in-oil emulsion.

The emulsion obtained presented a thick creamy spreadable texture and remained stable against sedimentation of droplets and against phase separation.

The amounts of ingredients used for obtaining the water-in-oil emulsion are indicated in Table 1.

TABLE 1
Ingredients

| Ingredients | Amount of Ingredient (% wt) |
|---|---|
| MCT oil (Neobee, Stepan Chemicals) | 71.4 |
| Hydrogenated Soy Oil | 7.1 |
| (Stable Flake, Cargill) | |
| Dimodan HP | 2.4 |
| Citrem Liq K | 2.4 |
| (Danisco) | |
| Water containing water-soluble flavor | 16.7 |

### Example 2

### Preparation of an Emulsion Flavor Ingredients Comprising Flavor Compositions in Dispersed and Continuous Phases

The emulsifiers (Citrem and Lecithin see table 2 hereunder) were mixed in an equal quantity of Sunflower oil (an edible oil) and heated to 65-70° C. to melt and dissolve. The remaining continuous Sunflower Oil and Cocoa Butter (solid fat particles F) are heated to 55° C. in a Thermomix at 100 rpm to melt and combine. The dissolved emulsifiers were then added to the bulk oils.

The two oil soluble flavors (Pork Fat Type Thermal Reaction Flavor from Firmenich and the Pork Sausage Type Liquid Flavor from Firmenich) were then added and dispersed in the oil continuous phase.

Setting the Thermomix to 300 rpm the water soluble flavor (Fatty Juicy Flavor aqueous phase) is gradually added to the oil phase in a continuous stream (approx. 100 g per minute) in order to achieve a fine dispersion and emulsification.

The emulsion is then transferred to a cooling vessel and rapidly cooled in an ice bath to 5-12 deg ° C. cooling at approximately 1.5° C. per minute with continuous stirring at 1500 rpm in order to achieve a cream like texture.

TABLE 2
Natural Vegan Fatty Juicy Pork type Emulsion Flavor Ingredients
at 1.5% used in model of extruded food products

| | Amt of | |
|---|---|---|
| Ingredients | Ingredient (% wt) | |
| Pork Fat Type Thermal Reaction Flavor | 14 | % |
| (Oil soluble flavor) (Firmenich) | | |
| Fatty Juicy Flavor (water soluble flavor) | 20 | % |
| (Firmenich) | | |
| Pork Sausage Type Liquid Flavor (Oil | 1.5 | % |
| soluble flavor) (Firmenich) | | |
| Cocoa Butter (Firmenich) | 15 | % |
| Emulsifier Citrem Liq (Firmenich) | 0.2 | % |
| Emulsifier Lecithin, Sunflower (Firmenich) | 0.4 | % |
| Sunflower Oil 80% Oleic Acid (Firmenich) | 48.9 | % |

### Example 3

### Example 3 Formulation Used in Model of Extruded Food Products:

Pork Fat Type Thermal Reaction Flavor (Oil soluble flavor) (Firmenich) 0.2% as consumed.

### Example 4

### Flavor Protection and Release in Model of Extruded Food Products

To check the performance of the flavor delivering system of the invention through the extrusion process, the comparison between extruded and non-extruded flavored Pea Protein Isolate samples was done by measuring the total concentration of volatiles released in headspace above slurries using analytical technique.

The water-in-oil emulsion flavor containing the pork flavor (Pork Fat Type Thermal Reaction Flavor (Oil soluble flavor) Firmenich) (Example 2) was mixed with Pea Protein Isolate (PPI) (Nutralys F85M, from Roquette freres) at 1.5% dosage and extruded at different temperatures. The oil reaction flavor (Pork Fat Type Thermal Reaction Flavor (Oil soluble flavor) Firmenich) (Example 3) was mixed with Pea Protein Isolate (PPI) (Nutralys F85M) at 0.2% dosage and extruded at different temperatures.

All flavored systems were evaluated using AFFIRM (Analysis of Flavors and Fragrances In Real time) at iso-protein concentration load.

20 grams of each extruded system was blended with 80 grams of water for 1 minute and transferred in a 500 ml Schott bottle. 8 grams of non-extruded flavored PPI powder was mixed with 92 grams of water in a 500 ml Schott bottle.

The Schott bottles were sealed, stirred and allowed to equilibrate for 1 hour. The headspace was sampled for 1 minute. The signal intensity of all the molecules released in the headspace was determined by subtracting the background signal from the unflavored sample signal.

The total ion signal intensity of the unflavored non-extruded pea protein isolate and unflavored extruded pea protein isolate samples at iso-protein concentration is represented in FIG. 1. The total signal intensity observed was higher for the non-extruded PPI comparing to the extruded PPI. Consequently, the processing of the PPI induced the decrease of the amount of volatile released in the headspace.

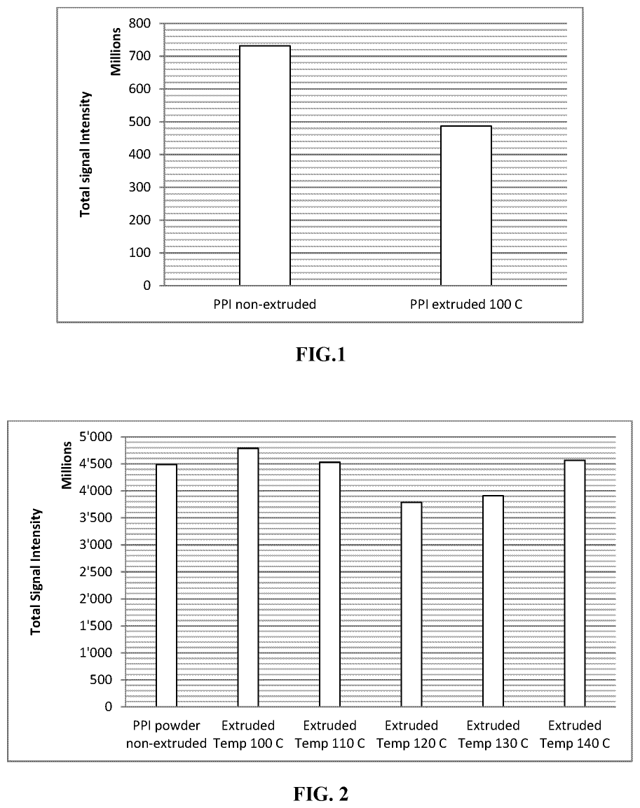

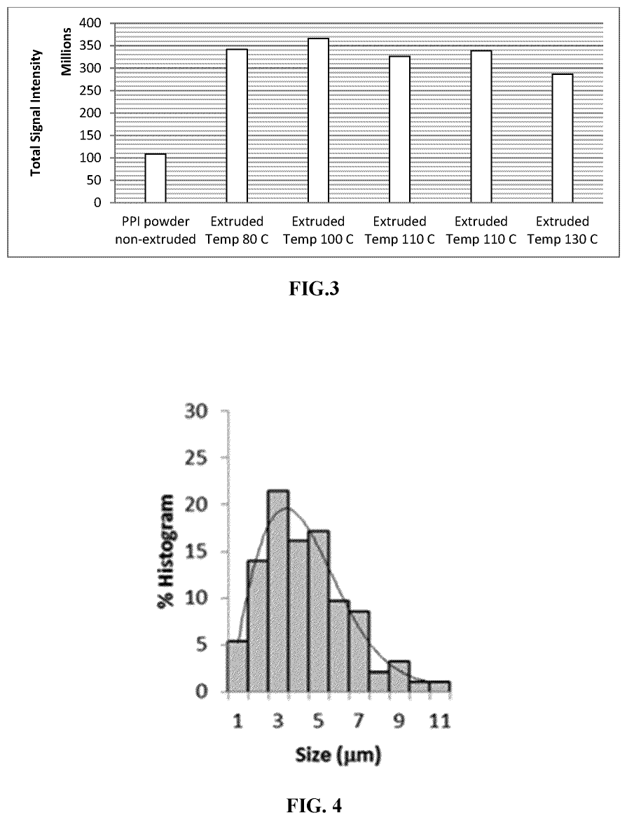

The total ion signal intensity of the flavored extruded water-in-oil emulsion pea protein isolate and flavored extruded oil reaction pea protein isolate samples is represented in FIGS. 2 and 3.

For the water-in-oil emulsion flavored sample (see FIG. 2) the total signal intensity remained relatively constant during the different extrusion conditions. The flavored extruded samples (see FIG. 3) have total signal intensities that are higher than the flavored non-extruded sample (100 million for the flavored non-extruded PPI powder and between 290 and 360 million for the flavored extruded PPI powder) and remains relatively constant independent of extrusion conditions This shows that the process described in the present invention ensures better flavor protection and release in processed food applications.

### Example 5

### Structure and Rheological Properties of Flavored Emulsions According to the Invention Emulsion Type and Drop Size Distribution

To confirm the emulsion type of the material as prepared in Example 1 and Example 2, dilution tests with heated hydrophobic vs. hydrophilic solvents were performed: a sample of 0.1 g of the material was mixed into 3 g of hot water (heated to 80° C.), and a second sample of 0.1 g of the material was mixed into equally heated isopropyl myristate (a hydrophobic solvent). Both samples were then observed by light microscopy.

In the sample mixed into heated isopropyl myristate, the heated emulsion blended and diluted well with the heated hydrophobic solvent, and dispersed emulsion droplets with an unambiguous size distribution could be observed by microscopy. In contrast, for the heated emulsion sample mixed into hot water, no blending and dilution was possible, and the material prepared according to the invention presented as an amorphous oily lump in the hot water.

This dilution tests confirmed that the emulsion type was water-in-oil; in a second part of the test, the droplet size distribution of the aqueous droplets diluted in heated isopropyl myristate was measured by image analysis using the software of the light microscope (Nikon Eclipse Software). The resulting drop size distribution is shown in FIG. 4, along with the results for the characteristic parameters. The number-based mean diameter is approx. 5 micrometers with a standard deviation of 2 micrometers.

### Rheological Characterization

In particular, the elastic modulus (G′) and the viscous modulus (G″) were measured during two different types of tests:

(a) Temperature sweep experiments, during which the material was subjected to shear oscillations with a constant frequency and strain amplitude, were used to measure G′ and G″ across a range of temperatures. This test probes the viscoelastic properties while the sample is exposed to a variation in temperature, thereby allowing to detect phase transitions such as melting or solidification.

(b) Strain amplitude sweep experiments performed at a constant temperature and constant frequency of oscillation, during which the strain amplitude was increased point by point, thereby allowing evaluating the viscoelastic properties under small to large shear oscillations.

In both kinds of tests, the relative magnitudes of the elastic (G′) and viscous (G″) moduli reveal the character of the material: G′>G″ means the material is predominantly elastic (‘solid-like’ and resistant to flow), whereas G″>G′ means the material is predominantly ‘fluid-like’. Likewise, the overall strength or softness of the material is reflected in the overall level of the moduli.

Temperature Sweep Experiments: Measurement of Viscoelastic Properties while Melting the Material Prepared According to the Invention

The temperature-dependent behaviour of the material as prepared in the previous examples is shown in FIG. 5 for the case of example 2 for a temperature sweep test performed from 5° C. to 80° C. while testing the sample under a very small oscillatory shear strain (constant shear strain amplitude of 0.3% and constant oscillation frequency of 0.5 Hz). From the lowest temperature up to approximately 18° C., the material remains hard and purely solid-like; in this regime the viscoelastic properties are controlled by the solid-like nature of the continuous fat phase below its melting point. Increasing the temperature leads to a strong decrease in the overall value of the moduli, as expected during a melting transition.

Surprisingly, however, even as the material prepared according to the invention melts, the elastic modulus remains superior to the viscous modulus, G′>G″. This behaviour is due to the presence of the dispersed phase in the material as formulated in Example 2 and it prevents the material from directly becoming purely liquid-like upon melting. This behaviour is in stark contrast to a classic, simple fat material, which simple becomes liquid upon melting.

This type of soft solid behaviour is advantageous for processing applications of the material, for example during extrusion processing, as it provides a barrier to flow for the material under applied stresses of the processing, thereby allowing to avoid excessive dispersion of the fat and consequently avoiding loss of structural integrity of the fat phase.

### Strain Amplitude Sweep Experiments: Viscoelastic Properties Above the Melting Temperature of the Continuous Fat Phase

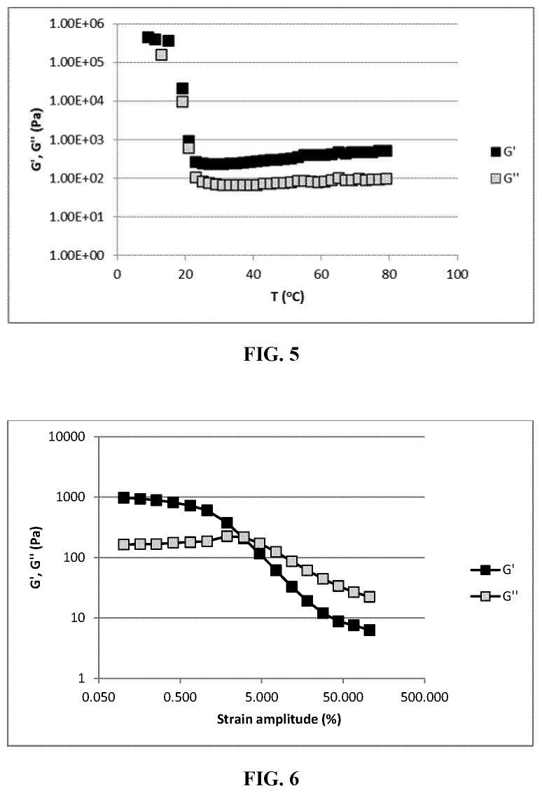

To further evaluate the soft-solid character of the material prepared according to the invention, FIG. 6 shows how the material behaves under increasing levels of applied shear strain. The sample as tested in the previous example was sheared using strain oscillations of constant frequency (0.5 Hz), but increasing amplitude, starting at very small strains around 0.1% and up to strains of 100% and more. This test was performed at a temperature of 37° C., which is well above the melting transition shown in FIG. 5. FIG. 6 clearly confirms that at small shear strains, the sample is predominantly elastic (G′>G″) and the viscoelastic parameters are roughly constant. As the shear strain increased, a rheological transition occurs: both moduli first decrease in magnitude, indicating that the sample weakens as it is shear, but still remains solid-like. At still higher strains, G′ and G″ cross over and the material ultimately becomes fluid-like (G″>G′); this transition happens at a shear strain of the order of 3-5%. Therefore, these data reveal that once the fat phase is molten, the material prepared according to Example 2 is a soft solid at rest and under small shear strains, yet it can be easily made to flow and become liquid-like if the shear strain is increased to higher values. Similar results were obtained with the emulsion of example 1. This type of rheological behaviour has two advantages:
(i) In food processing: it is desirable to have a material that can be easily dispersed into droplets or particles by shearing in the manufacturing process (such as liquid blending, or extrusion), but that retains its shape and integrity once the shearing is over. In particular, having such a material allows to avoid undesired oil separation form the final or intermediate food product, or to avoid undesired penetration of the oil through the food product. The emulsion as described here possesses these properties, in contrast to a traditional simple oil or molten fat.
(ii) For sensory/texture perception, during eating of food products: rheological characteristics as described in this example can impart desirable organoleptic properties onto food products, related to texture attributes such as juiciness, mouthfeel, mouthcoating, thickness (see for example Le Calvé et al, Fat perception: How sensitive are we?, Journal of Texture Studies, 46, 200, 2015).

### Example 6

### Sample Emulsion Ingredients

Table 3 below shows typical ingredients for an emulsion according to certain embodiments of the present disclosure. Amounts are given in percent by weight, based on the total weight of the emulsion.

TABLE 3

| Ingredients | Function | Amount |
|---|---|---|
| Cocoa butter | Fat | 25-31 |
| Sunflower oil High oleic | Liquid Oil | 20-26 |
| Coconut oil | Fat | 9-15 |
| Acid palmitic | Fat, waxy taste | 6-10 |
| Beef fat flavor | Flavor & Aroma | 2-4 |
| Rapeseed Mono/Diglycerides | Emulsifier | 1-3 |
| Lecithin | Emulsifier | 1-3 |
| Water | Matrix | 9-15 |
| Tasty Flavor | Taste | 3-5 |
| Sucrose | Taste | 2-4 |
| Pea Fiber | Thickener, Stabilizer | 1-4 |
| Lactic acid | Acidity | 0.5-2.0 |
| Salt | Stability, Taste | 0.2-1.0 |
| Citric acid | Acidity | 0.1-0.5 |

### Example 7

### Sample Beef Replacement Ingredients

Table 4 below shows typical ingredients for an artificial beef product that includes emulsions of Example 6. Amounts are given in percent by weight, based on the total weight of the emulsion.

TABLE 4

| Ingredients | Function | Amount |
|---|---|---|
| Texturized Pea Protein | Texture | 18-25 |
| Methyl Cellulose | Thickening | 0-3 |
| Water | Hydration | 55-65 |
| Rapeseed oil | Liquid Oil | 0-10 |
| Coconut oil | Solid Fat | 0-10 |
| Beef Fat Emulsion Flavor (Ex. 6) | Aroma and Taste | 0.5-4.0 |
| Wheat Gluten | Texture | 2-8 |
| Super Fiber Plus (Campus) | Moisture Holding | 0.5-3.0 |
| Onion Powder | Flavor | 0.2-1.2 |
| Salt | Taste | 0.2-1.2 |
| Glucose Monohydrate | Color | 0.1-0.6 |
| Black Pepper Grnd | Flavor | 0.05-0.20 |

### Example 8

### Sensory Testing

A plant-based hamburger was made according to Example 7, and evaluated in comparison to a comparable hamburger in which the rapeseed oil, coconut oil, and flavouring emulsion were replaced with beef tallow. A group of eight (8) expert sensory panellists tasted the two hamburgers and evaluated their taste. The results of the sensory testing (as an average) are shown in Table 5.

TABLE 5

| Sensory Element | With Emulsion | With Beef Tallow |
|---|---|---|
| Satliness | 3.4 | 4.0 |
| Juiciness | 4.9 | 4.5 |
| Beef Flavor | 3.9 | 4.3 |
| Fatty Flavor | 4.8 | 4.5 |
| Overall Liking | 4.3 | 3.8 |
| Pea Flavor | 3.1 | 2.4 |

For each of these measures, the differences were not statistically significant, suggesting that expert sensory testers could not distinguish significantly between a hamburger containing beef tallow versus one containing vegetable fats and a flavouring emulsion of the present disclosure.

1. A fatty composition, which comprises solid fat particles dispersed within a liquid oil, wherein the solid fat particles comprise a plant-derived fat, and wherein the liquid oil comprises a plant-derived oil.

2. The fatty composition of claim 1, wherein the solid fat particles comprise a plant-derived fat selected from the group consisting of: cocoa butter, palm fat, palm kernel fat, coconut fat, and any combinations thereof.

3. The fatty composition of claim 1, wherein the solid fat particles comprise cocoa butter.

4. The fatty composition of claim 1, wherein the melting point of the solid fat particles is at least 30° C.

5. The fatty composition of claim 1, wherein the melting point of the solid fat particles is no higher than 80° C.

6. The fatty composition of claim 1, wherein the melting point of the liquid oil is no higher than 15° C.

7. The fatty composition of claim 1, further comprising one or more fat-soluble flavor compounds.

8. The fatty composition of claim 1, further comprising an emulsifier.

9. An emulsion, which comprises a continuous phase and a dispersed phase, wherein the continuous phase comprises the fatty composition of claim 1, and the dispersed phase comprises an aqueous medium.

10. The emulsion of claim 9, wherein the dispersed phase makes up from 0.1% by weight to 50% by weight, based on the total weight of the emulsion.

11. The emulsion of claim 9, wherein the aqueous medium comprises a water-soluble fiber.

12. (canceled)

13. (canceled)

14. A comestible article comprising a plant-derived protein, a plant-derived fiber, and an emulsion of claim 9.

15. The comestible article of claim 14, which is a meat analogue product.
